(19) United States
(12) Patent Application Publication
(10) Pub. No.: US 2026/0192220 A1
(43) Pub. Date: Jul. 9, 2026

(54) SHIRRED FILTER MEDIA AND METHODS OF MAKING AND USING THE SAME

(71) Applicant: 3M INNOVATIVE PROPERTIES COMPANY, St. Paul, MN (US)

(72) Inventors: Nathan E. Schultz, Woodbury, MN (US); Daniel J. Zillig, Woodbury, MN (US); Wenli Wang, Woodbury, MN (US); Zhiqun Zhang, North Oaks, MN (US)

(21) Appl. No.: 19/127,849

(22) PCT Filed: Nov. 30, 2023
(86) PCT No.: PCT/US2023/081821

§ 371 Date: May 7, 2025

Related U.S. Application Data
(60) Provisional application No. 63/434,365, filed on Dec. 21, 2022.

(51) Int. Cl. B01D 39/08; B01D 46/00

(52) U.S. Cl. CPC B01D 39/08; B01D 46/0001; B01D 2239/0435; B01D 2239/0622; B01D 2239/10

(57) ABSTRACT

Described herein is method for making a shirred filter media and articles made therefrom, wherein a first series of substantially parallel non-bonded elastic filaments are positioned between a first and a second non-woven porous fibrous web and wherein the first non-woven porous fibrous web is directly bonded to the second non-woven porous fibrous web. At least one portion of the shirred filter media is resiliently extensible under tension. Such shirred articles may be used for the filtering particulates from air or vaporous fluids.

### TECHNICAL FIELD

A shirred filter media is described along with a method of making such media. The shirred filter media is useful in various applications including high loading capacity applications and vaporous fluid applications.

### SUMMARY

There is a desire to identify a filter media which has improved aerosol loading and/or reduced pressure drop.

In one aspect, a shirred filter media is described comprising a first series of substantially parallel non-bonded clastic filaments between a first and a second non-woven porous fibrous web, wherein the first non-woven porous fibrous web is directly bonded to the second non-woven porous fibrous web, wherein at least one portion of the shirred filter media is resiliently extensible under tension.

In one embodiment, at least one of the first or second non-woven porons fibrous webs comprise electret filaments or fibers.

In one embodiment, the shirred filter media can be used in a respirator application. In another embodiment, the shirred filter media can be used in a furnace or air conditioning application.

In another aspect, method of making a shirred filter media is described. The method comprising: (i) stretching a first series of substantially parallel non-bonded elastic filaments to a first length forming stretched filaments; (ii) placing the stretched filaments between a first and a second non-woven porous fibrous web forming a multilayered construction; (iii) bonding the first non-woven porous fibrous web to the second non-woven porous fibrous web with the stretch filaments therebetween; and (iv) releasing the stretched filaments to form the shirred filter media, wherein at least one portion of the shirred filter media is resiliently extensible under tension.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a schematic representation showing the shirred filter media.

FIG. 2 is a schematic representation of a cross section of the shirred filter media, showing its construction.

FIG. 3 is a schematic representation of making a shirred filter media according to one embodiment of the present disclosure.

FIG. 4 is a topology map of a major surface of EX 3.

FIG. 5 is a topology map of a major surface of EX 15.

FIG. 6 is a topology map of a major surface of EX 14.

FIGS. 7A and 7B arc topology maps of opposing major sides of EX 16.

It should be understood that numerous other modifications and embodiments can be devised by those skilled in the art, which fall within the scope and spirit of the principles of the disclosure. The schematic figures may not be drawn to scale.

### DETAILED DESCRIPTION

As used herein, the term

“a”. “an”, and “the” are used interchangeably and mean one or more; and “and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of”′ A, B, and C refers to element A by itself, element B by itself, element C by itself, A and B, A and C, B and C, and a combination of all three.

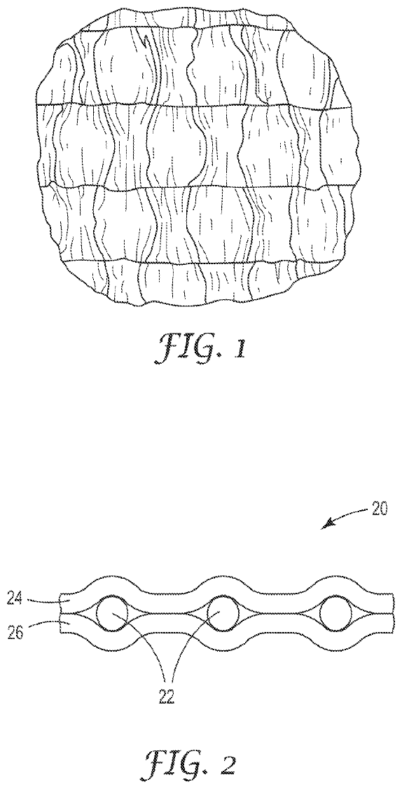

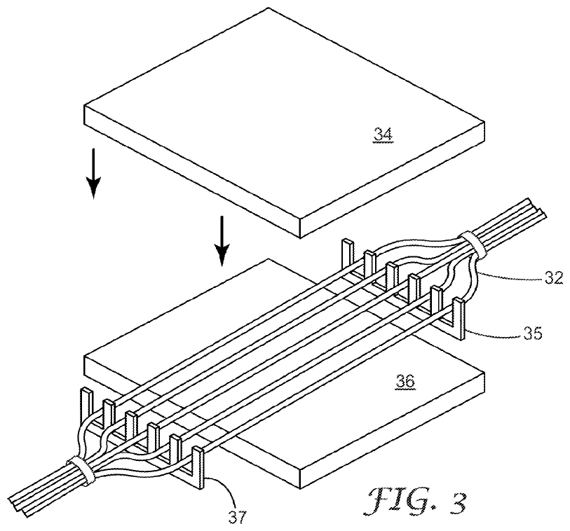

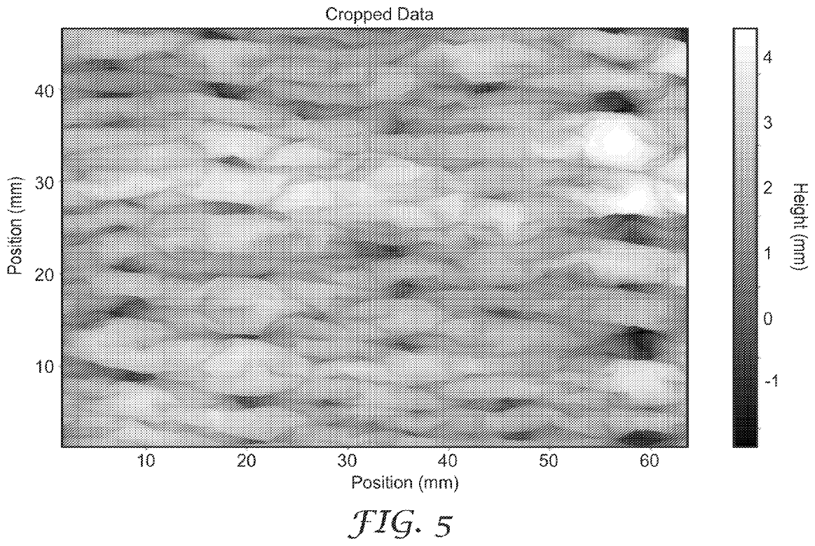

Shown in FIG. 1 is top view of an exemplary embodiment of a shirred filter media of the present disclosure. Shirred filter media 10 comprises a plurality of elastic filaments that are spaced apart. The plurality of elastic filaments are sandwiched between two non-woven porous fibrous webs. During fabrication of the shirred filter media (herein referred to as “media”), the elastic filaments are pulled under tension, such that when the tension is released, the non-woven porous fibrous webs become puckered. Shown in FIG. 2 (not drawn to scale) is a side view showing a first non-woven porous fibrous web 24 and a second non-woven porous fibrous web 26, with elastic filaments 22 positioned therebetween. FIG. 2 shows that first non-woven porous fibrous web 24 is in direct contact with second non-woven porous fibrous web 26. Images of actual shirred articles made according to the present disclosure are shown in FIGS. 4-6 and 7A and 7B. Based on the resulting articles, it is believed that when adhesive is used, the adhesive bonds the two non-woven porous fibrous webs together with the filaments therebetween. It is assumed that the bonding of the first and second non-woven porous fibrous webs is discontinuous and that the non-woven porous fibrous web(s) may not be bonded (for example, adhesively bonded) to the filament along the entire length of the filament.

### Elastic Filaments

The filaments of the present application comprise a polymer and are elastic in nature, meaning that the filament is capable of recovering or at least partially recovering in length following stretching. For example, at least partially recovering can refer to recovering at least 10, 15, or even 20% from the original stretch percentage.

In some embodiments, more than one filament may be coupled together (for example, twisted) to form a thread. As used herein, “filament” can refer to a single elastic fiber or a bundle of filaments in the form of a yarn.

Exemplary types of polymeric materials that may be used for filaments of the present application include: natural rubber, synthetic rubber, polyether-polyurethanes, polyamides, polyisoprenes, copolymers of isoprene and neoprene, polymers of 2-chloro-1,3-butadiene, polyether-polyurea copolymer (e.g., Lycra), polyurethane (e.g., spandex). Other examples include tri-block polymers available under the trade designation KRATON from Kraton Polymer US LLC, Houston, TX, the elastic copolymers comprise high Tg end blocks made of polystyrene and low Tg center block made of one or more isoprene, butadiene, and the like. Exemplary filaments include a propylene and ethylene co-polymer with a density of 0.85 to 0.9 g/cm3 and one available under the trade designation 100% LYCRA SPANDEX 235 MULTIFIL, DTEX Type 737, 210 denier from Invista Company, Wichita, KS.

In one embodiment, the filaments have an average diameter of at least 1, 5, 10, or even 20 micrometers and at most 25, 50, 100, 200, 400, 600, 800, 1000, or even 1200 micrometers. In one embodiment, the filaments have a denier of at least 100, 150, 175, 200, 210, 220, 250, or even 500. In one embodiment, the filaments have a denier of at most 1200, 1000, 900, 800, 700, 600, 500, 400, 350, 300, 250, or even 225 denier.

### Non-Woven Porous Fibrous Web

The plurality of elastic filaments is positioned between two non-woven porous fibrous webs, herein referred to as a non-woven web. The nonwoven webs of the present disclosure can be made by wet laid, carded, air laid, spunlaced, spunbonding, or melt-blowing techniques or combinations thereof. Spunbonded fibers are formed by extruding molten thermoplastic polymer as filaments from a plurality of fine, usually circular capillaries of a spinneret with the diameter of the extruded fibers being rapidly reduced. Meltblown fibers are typically formed by extruding the molten thermoplastic material through a plurality of fine, usually circular, die capillaries as molten fibers or filaments into a high velocity, usually heated gas (e.g., air) stream which attenuates the filaments of molten thermoplastic material to reduce their diameter. Thereafter, the meltblown fibers are carried by the high velocity gas stream and are deposited on a collecting surface to from a web of randomly dispersed meltblown fibers. Any of the non-woven webs may be made from a single type of fiber or two or more fibers that differ in the type of thermoplastic polymer and/or thickness.

Suitable thermoplastic polymeric materials include, but are not limited to, polyolefins (such as polypropylene, or polyethylene), poly(isoprenes), poly(butadienes), fluorinated polymers, chlorinated polymers, polyamides, polyimides, polyethers, poly(ether sulfones), poly(sulfones), poly(vinyl acetates), polyesters such as poly(lactic acid), copolymers of vinyl acetate, such as poly(ethylene)-co-poly(vinyl alcohol), poly(phosphazenes), poly(vinyl esters), poly(vinyl ethers), poly(vinyl alcohols), and poly(carbonates).

Suitable polyolefins include, but are not limited to, poly(ethylene), poly(propylene), poly(l-butene), poly-4-methyl-1-butene, copolymers of ethylene and propylene, alpha olefin copolymers (such as copolymers of ethylene or propylene with 1-butene, 1-hexene, 1-octene, and 1-decene), poly(ethylene-co-1-butene) and poly(ethylene-co-1-butene-co-1-hexene).

Suitable fluorinated polymers include, but are not limited to, poly(vinyl fluoride), poly(vinylidene fluoride), copolymers of vinylidene fluoride (such as poly(vinylidene fluoride-co-hexafluoropropylene), and copolymers of chlorotrifluoroethylene (such as poly(ethylene-co-chlorotrifluoroethylene).

Suitable polyamides include, but are not limited to, typical nylon polymers such as poly(iminoadipoyliminohexamethylene), poly(iminoadipoyliminodecamethylene), and polycaprolactam. Suitable polyimides include, but are not limited to, poly(pyromellitimide).

Suitable poly(ether sulfones) include, but are not limited to, poly(diphenylether sulfone) and poly(diphenylsulfone-co-diphenylene oxide sulfone).

Suitable copolymers of vinyl acetate include, but are not limited to, poly(ethylene-co-vinyl acetate) and such copolymers in which at least some of the acetate groups have been hydrolyzed to afford various poly(vinyl alcohols).

The fibers selected for the non-woven web depend upon the kind of particulate to be filtered. Particularly useful fibers include webs of melt-blown fibers, such as those disclosed in Wente. Van A., SUPERFINE THERMOPLASTIC FIBERS, 48 Industrial Engineering Chemistry, 1342 et seq (1956). Webs of meltblown fibers provide especially good filtration layers when used in a persistent electrically charged form (see U.S. Pat. No. 4,215,682 to Kubik et al). Preferably, these melt-blown fibers are microfibers having an average diameter of at least 4, 6, 8 or even 10 micrometers and at most 12, 14, 16 or even 20 micrometers. Other particularly useful filtration fibers are electrically-charged-fibrillated-film-fibers as disclosed in U.S. Pat. No. RE 31,285 (Van Turnhout et al.). Additional particularly useful fibers include high loft spunbonded webs (see U.S. Pat. No. 8,240,484 Fox et al.). Rosin wool fibrous webs and webs of glass fibers are also useful, as are solution blown, or electrostatically sprayed fibers, especially in microfiber form.

The non-woven webs are porous, meaning that the outside surface of one side of the non-woven web is in fluid communication with the outside surface on the opposing side of the same non-woven web. This ensures flow of vaporous fluids, air, or liquids through the non-woven web. The non-woven webs are coextensive meaning that the web is a complete, continuous layer of non-woven material with no rips or tears.

In one embodiment, at least one of the non-woven webs of the present disclosure comprises electret fibers. Electrets are a dielectric material that possess a quasi-permanent electric charge or dipole polarization. Electrets typically are improved by incorporating a charging additive into a polymeric material and then inducing a charge onto the polymeric materials using a corona treatment, a tribocharging treatment, a hydrocharging treatment, or combinations thereof. In one embodiment, the electret fibers are monocomponent fibers. In another embodiment, the electret fibers are bicomponent fibers, such as sheath-core, side-by-side, etc. In one embodiment, the electret fibers are sheath-core fibers comprising a core having a coextensive sheath layer disposed thereon. In one embodiment, the core comprises an electrostatic charge enhancing additive. In one embodiment, the sheath comprises an electrostatic charge enhancing additive. In one embodiment, the electret fibers are side-by-side, wherein the fiber comprises two components lying next to each other along the length of the fiber. In one embodiment, the electret fibers are so called “islands-in-the-sea” extrudates, wherein multiple fiber cores (i.e., more than 1, 2, 4, or even 6 cores) are distributed within a polymer matrix, which also forms the sheath.

Many charge enhancing additives for making electret-containing fiber webs are known in the art. Exemplary electrostatic charge enhancing additives may include pigments, light stabilizers, primary and secondary antioxidants, metal deactivators, hindered amines, hindered phenols, metal salts, phosphite triesters, phosphoric acid salts, fluorine-containing compounds, and combinations thereof. Preferably, the charge enhancing additive is a solid at ambient conditions to prevent migration within the resin and does not decompose at moderate temperatures. In one embodiment, the charge enhancing additive is a solid at temperatures of at least 25, 30, 40, 50, 60, 80 or even 100° C. In one embodiment, the charge enhancing additive does not decompose, for example, there is no significant weight loss (i.e., less than 5, 1, or even 0.1 wt %) when measured under nitrogen by thermogravometrie analysis using a ramp rate of 10° C./min to heat up to 235° C.

Particularly preferred change enhancing additives include hindered amine-based additives, triazine-based additives, and hindered phenol-based additives.

Specific examples of the hindered amine-based or triazine-based additives include (poly [[6-(1,1,3,3,-tetramethylbutyl)amino]-s-triazine~2,4-diyl][ ](2,2,6,6-tetramethyl-4-piperidyl)imino]hexamethylene [(2,2,6. 6-tetramethyl-4-piperidyl)imino]]), available under the trade designation CHIMASSORB 944 from BASF. Ludwigshafen, Germany; dimethyl succinate-1-(2-hydroxyethyl)-4-hydroxy-2,2,6,6-tetramethylpiperidine polycondensate, available under the trade designation TINUVIN 622 from BASF; di-tert-butyl-4-hydroxybenzyl)-2-n-butyl malonate bis(1,2,2,6,6-pentamethyl-4-piperidyl available under the trade designation TINUVIN 144 from BASF; a polycondensate of dibutylamine-1,3,5-triazine-N,N′-bis(2,2,6,6-tetramethyl-4-piperidyl-1,6-hexamethylenediamine-N-(2,2,6,6-tetramethyl-4-piperidyl)butylamine, available under the trade designation CHIMASSORB 2020 from BASF; 2-(4,6-diphenyl-1,3,5-triazin-2-yl)-5-((hexyl)oxy)-phenol, available under the trade designation TINUVIN 1577 from BASF; N-substituted amino aromatic compounds, particularly tri-amino substituted compounds, such as 2,4,6-trianilino-p-(carbo-2′-ethylhexyl−1′-oxy)-1,3,5-triazine, available under the trade designation UVINUL T-150 from BASF; and 2,4,6-tris-(octadecylamino)triazine, also known as tristearyl melamine (“TSM”)

Hindered phenol-based additives having a hydroxyl group as the terminal functional group, he hindered phenol-based additives are not particularly limited, and specific examples include pentaerythrityl-tetrakis [3-(3,5-di-tert-butyl-4-hydroxyphenyl) propionate](IRGANOX 1010, manufactured by BASF), octadecyl-3-(3,5-di-tert-butyl-4-hydroxyphenyl) propionate (IRGANOX 1076, manufactured by BASF), tris-(3,5-di-tert-butyl-4-hydroxybenzyl)-isocyanurate (IRGANOX 3114, manufactured by BASF). 3,9-bis-{2-[3-(3-tert-buty]-4-hydroxy-5-methylphenyl)-propionyloxy 1-1,1-dimethylethyl}-2,4,8,10-tetraoxaspiro-[5,5]undecane (SUMILIZER-GA-80, manufactured by Sumitomo Chemical Co., Ltd.), and the like.

Additional thermally stable organic triazine compounds or oligomers, which compounds or oligomers contain at least one nitrogen atom in addition to those in the triazine ring, are disclosed in U.S. Pat. Nos. 6,268,495, 5,976,208, 5,968,635, 5,919,847, and 5,908,598 to Rousseau et al.

Further examples of charge-enhancing additives are provided in U. S. Publ. No. 2011/0137082 (Li et al.). U. S. Pat. Nos. 8613795 (Li et al.), 7,390,351 (Leir et al.), U.S. Pat. No. 5,057,710 (Nishiura et al.), and U.S. Pat. Nos. 4,652,282 and 4,789,504, both to Susumu et al., and U.S. Pat. No. 8,790,449 B2 (Li et al.).

The charge-enhancing additive(s) can be added in any suitable amount. The charge-enhancing additives of this disclosure may be effective even in relatively small quantities. Typically, the charge-enhancing additive is present in a thermoplastic resin and charge-enhancing additive blend in amounts of up to about 10% by weight, more typically in the range of 0.02 to 5% by weight based upon the total weight of the blend. In some embodiments, the charge-enhancing additive is present in an amount ranging from 0.1 to 3% by weight, 0.1 to 2% by weight, 0.2 to 1.0% by weight, or 0.25 to 0.5% by weight.

### Method of Making

In one embodiment, the shirred filter media of the present application can be made by stretching a first series comprising a plurality of elastic filaments. The filaments are not generally bonded to one another (for example, the filaments of the present disclosure are not a scrim). The plurality of elastic filaments in the first series are held (for example using a spacer) such that each of the filaments is substantially parallel to one another and are spaced a given distance apart. Generally, the substantially parallel filaments should not touch the nearest neighbor filament in the working portion of the finished good. In one embodiment, the elastic filaments are held with a spacing of at least 2, 4, 5, or even 6 filaments per inch. In one embodiment, the elastic filaments are held with a spacing of at most 8, 10, 12, 15, 20, or even 25 filaments per inch. Generally, the spacing of the filaments is selected to achieve the desired shirring of the non-woven web without causing a large change in pressure.

The filaments can be stretched to a desired length before it reaches its elastic limit or yield point. The % stretch as used herein is defined as the difference between the length of the stretched filament and the length of the initial filament divided by the length of the initial filament converted to a percent. In one embodiment, the elastic filaments are stretched to greater than 50, 75, 100, 150, 200, or even 250%. The filaments can be stretched more than 250% so long as the filaments do not go beyond the elastic limit to deformation or break during the manufacturing of the shirred media disclosed herein. The first and second non-woven webs are positioned on either side of the stretched filaments.

The first and second non-woven webs may be the same or different. The non-woven webs are selected based on the desired performance properties. The non-woven webs selected may be different in terms of composition, basis weight, thickness, porosity, etc.

The first and second non-woven webs are bonded directly together such that the first non-woven web contacts the second non-woven web, optionally with the use of an adhesive as exemplified below. In one embodiment, an adhesive is used to directly bond (or adhere) the first and second non-woven webs together. Such adhesives can include a pressure sensitive adhesive or a hot melt adhesive. Pressure sensitive adhesives are known in the art and are generally adhesives that can adhere based on room temperature conditions when pressure (e.g., finger pressure) is applied. Exemplary pressure sensitive adhesives include: a natural latex or synthetic polymer such as a (meth)acrylate. A commercially available pressure sensitive adhesive includes a spray adhesive available under the trade designation 3M SUPER 77 MULTIPURPOSE ADHESIVE by 3M Co., Maplewood, MN, USA. Hot melt adhesives are those adhesives that are thermoplastic polymers which are heated above their softening point and when applied in their softened state to a surface, penetrate the surface and solidify ensuring cohesion. Exemplary hot melt adhesives include: Bostik HM-9041 available from Bostik inc., Wauwatosa, WI. In the embodiments of the present application when an adhesive is applied, the weight of adhesive used per unit area is less than the weight per unit area of the non-woven web. In one embodiment, the weight per unit area of the adhesive is less than 0.5, 0.4, 0.3, 02, or even 0.1% of the weight per unit area of the non-woven porous fibrous webs in the article. Ideally, the adhesive should not interfere with the performance of the article and should be collapsible, meaning that the adhesive can maintain cohesiveness (or keep the two layers of non-woven webs bonded) upon the relaxing of the stretched filaments during manufacture. In one embodiment, the adhesive is at least 1, 2, 4, 5, or even 6 gsm (grams per square meter) in the shirred article. In one embodiment, the adhesive is at most 8. 10, 15, 20, 40, 60, or even 80 gsm in the shirred article. In another embodiment, the first and second non-woven webs are welded directly together such that the first non-woven porous fibrous web is in intimate contact with the second non-woven porous fibrous web. Such welding techniques are known in the art and include thermal bonding or ultrasonic welding.

After bonding (or adhering) the first and second non-woven porous fibrous webs together, the tension is released on the stretched elastic filaments and the resulting article puckers or becomes shirred as represented schematically in FIG. 1. Typically, after the tension is released on the stretched elastic filaments, it could take upwards of a day for the shirred article to achieve its final puckered state as an equilibrium in the construction is reached. In one embodiment, the heat can be used to more quickly achieve this stable state.

In addition to the first and second non-woven webs, additional layers (e.g., a third layer) maybe added onto the shirred article to provide additional functionality. The third layer may be added before release of the tension on the filaments, such that the third layer is also puckered or shirred. In another embodiment, the third layer is added after release of the tension on the filaments, such that the third layer is a flat layer bonded to the puckered or shirred article. Exemplary third layers include cover webs, which is a layer used to protect the underlying article from abrasion, soiling, etc.

In another embodiment, in addition to the first series of elastic filaments, a second series of filaments can also be used, wherein the first and second series of elastic filaments are positioned non-parallel to each other (for example at least 45 degrees or at least 90 degrees apart). The shirred article is made as described above, except that both series of elastic filaments are placed between the two non-woven webs. When tension is released on both series of filaments, the resulting article has a more complex puckered pattern as shown in the Example Section.

In yet another embodiment, the series of elastic filaments may be stretch to different percentages, such that when the tension is released the resulting puckered material comprises areas with more puckering and areas with less puckering.

The articles of the present disclosure are resiliently extensible under tension, meaning that when the puckered article is pulled in the same direction as the length of the clastic filaments, the puckered article can elongate (or flatten out) and when the tension is released, the elongated article returns to its puckered form. In one embodiment, the puckered article is elastically extensible to at least 2 or even 3 times of its relaxed length. In some embodiments, the puckered article comprises at least one portion which is resiliently extensible under a first tension, wherein a second portion of the shirred filter media is under a second tension. In some embodiments, the puckered article is held in its elongated state.

Because the articles of the present disclosure have a puckered (or shirred) appearance, the basis weight of the resulting article has a higher basis weight than the original flat or unwrinkled non-woven porous fibrous webs. In one embodiment, the shirred articles of the present disclosure have a basis weight of at least 10, 15, 20, 30, 40, 50, 75, or even 100 grams per square meter (gsm). In one embodiment, the shirred articles of the present disclosure have a basis weight of at most 100, 125, 150, 175. 180, 200, 225. 250, or even 275 gsm.

The articles of the present disclosure are self-supporting meaning that an additional layer is not needed to provide support to the non-woven web/filament/non-woven web construction, optionally comprising an adhesive.

The puckered or shirred articles of the present disclosure can have utility in filtering fluids, such as air or vaporous fluids. Such articles can be used to filter out undesirable particles from the fluids, such as dust, molds, oily mist aerosol, cigarette smoke, pet dander, viruses, bacteria, ctc.

The filter media of the present disclosure described herein may have a variety of suitable air permeabilities. In one embodiment, the filter media has an air permeability of greater than or equal to 2, 5, 10, 15, 20, 25. 30, 40, 50, 75, 100, 120, 150, 170, 200, 275, 300, 350, or even 400 CFM. In some embodiments, the filter media has an air permeability of less than or equal to 450, 400, 350, 325, 300, 275, 250, 225, 200, 170, 150, 120, 100, 75, 60, 50, 40, 35, 30, or even 25 CFM. Combinations of the above-referenced ranges are also possible (e.g., greater than or equal to 20 CFM and less than or equal to 350 CFM, greater than or equal to 35 CFM and less than or equal to 170 CFM, or greater than or equal to 20 CFM and less than or equal to 350 CFM). Other ranges are also possible. The air permeability of a filter media may be determined in accordance with ASTM Test Standard D737 (1996) under a pressure drop of 125 Pa on a sample with a test area of 1 in² or 2.75 in² (6.45 or 17.7 cm²).

In one embodiment, the articles of the present disclosure can be used as a respirator. In a respirator application, the shirred article can be formed into the shape of a face mask to be worn by an individual.

In another embodiment, the articles of the present disclosure can be used as or incorporated into a heating, ventilation, and/or air conditioning equipment filter; an air purifier filter; an air conditioning device filter; a portable fan filter; or a vent filter.

As mentioned above, the puckered article is not only resiliently extensible under tension, but the puckered article may be held in its elongated state during use. This expanded condition use may be particularly advantageous in providing a filtration solution that can be used in a variety of filter dimensions, i.e., it can provide a more universal filter size. The expanded condition of the shirred media may be characterized by an expansion ratio, which is defined as the ratio of the expanded length of the media to the at-rest length of the media, where length is the dimension parallel to the orientation of the elastic strands. The shirred media may be used while maintained at an expansion ratio of greater than or equal to 1.1. 1.2, 1.5, 1.8, or even 2.0.

In some embodiments, the expanded media could be expanded together with an expandable filter frame; the expanded media could be used in dimensionally fixed filter frames with different dimensions; or the expanded media could also be used in a frameless configuration.

In yet another embodiment, the puckered or shirred media could be used in a refillable filter assembly wherein the puckered or shirred media is transported and stored in a compacted, relaxed condition prior to expanding the media and attaching it to a refillable filter frame.

Generally, many different sizes of residential HVAC filters exist, and it can be inefficient for manufacturers and retailers to stock every size. Using a shirred media according to the present disclosure at different expansion ratios could allow a single filter to cover many filter size needs. For example, a shirred media in an unexpanded form could be fit into an adjustable frame starting with a 16×20 inch dimension; the filter could then be expanded to reach a 20×20 inch dimension, and it could potentially be further expanded to reach a 25×20 inch dimension, or it could be expanded to any point in-between. The filter media would need to be attached to two ends of the adjustable frame with mechanical and/or adhesive means to secure the media against the contraction forces exhibited on the media while in an expanded state, e.g., using the methods found in U.S. Pat. No. 7,169,202 (Kubokawa). Exemplary frame constructions suitable for adjustable size filers can be found in U.S. Pat. No. 10,981,099 (Gregerson et al.), and 11,642,617 (Fox, et al.).

To assess filtration performance, a variety of filtration testing protocols have been developed. These tests include measurement of the aerosol penetration of the filter web using a standard challenge aerosol such as sodium chloride (NaCl) or dioctylphthalate (DOP), which is usually presented as percent of aerosol penetration through the filter web (% Pen) and measurement of the pressure drop across the filter web (ΔP). From these two measurements, a quantity known as the Quality Factor (QF) may be calculated by the following equation:

$$QF = - ln ( \% Pen / 100 ) / Δ P ,$$

where In stands for the natural logarithm. A higher QF value indicates better filtration performance, and decreased QF values effectively correlate with decreased filtration performance. Details for measuring these values are presented in the Examples section. Typically, the charged filtration media of this disclosure have measured QF values of 0.3 (mm of H₂O)⁻¹ or greater at a flow rate of 85 liters/minute (LPM) and a circle diameter of 4.5 inches (11.4 centimeters).

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

Materials Table

| Name | Source |
|---|---|
| Adhesive | Spray adhesive available under the trade designation 3M SUPER 77 |
| | MULTIPURPOSE ADHESIVE by 3M Co., Maplewood, MN, USA |
| filament | Spandex fibers rolled on a spool available under the trade designation 100% |
| | LYCRA SPANDEX 235 MULTIFIL, DTEX Type 737, 210 denier from |
| | Invista Company, Wichita, Kansas. |
| Web F1 | A non-woven melt blown fibrous web comprising polypropylene fibers |
| | having an effective fiber diameter of 5 micrometers, with a charging additive |
| | package as described in U.S. Pat. No. 10,724,171 (Schultz et al.), which can be |
| | prepared per Process A and Charging Method 3 as disclosed in U.S. Pat. No. |
| | 10,724,171, having a basis weight of 44 gsm, a thickness of 0.021 in (0.53 |
| | mm) and a % solidity of 9.1%, and a quality factor of at least 0.73. |
| Web F2 | A non-woven melt blown fibrous web comprising polypropylene fibers |
| | having an effective fiber diameter of 7.5 micrometers, with a charging |
| | additive package as described in U.S. Pat. No. 10,724,171, which can be prepared per |
| | Process A and Charging Method 3 as disclosed in U.S. Pat. No. 10,724,171, having a |
| | basis weight of 61 gsm, a thickness of 0.038 in (0.96 mm) and a % solidity |
| | of 7.2%, and a quality factor of at least 0.94. |
| Web F3 | A non-woven melt blown fibrous web comprising polypropylene fibers |
| | having an effective fiber diameter of 12.5 micrometers, with a charging |
| | additive package as described in U.S. Pat. No. 10,724,171, which can be prepared per |
| | Process A and Charging Method 3 as disclosed in U.S. Pat. No. 10,724,171, having a |
| | basis weight of 61 gsm, a thickness of 0.039 in (0.99 mm) and a % solidity |
| | of 6.7%, and a quality factor of at least 0.91 measured at 85 lpm using a |
| | DOP aerosol. |
| Web F4 | A non-woven melt blown fibrous web comprising polypropylene fibers |
| | having an effective fiber diameter of 7.0 micrometers, with a charging |
| | additive package as described in U.S. Pat. No. 10,724,171, which can be prepared per |
| | Process A and Charging Method 3 as disclosed in U.S. Pat. No. 10,724,171, wherein |
| | the quality factor is at least 0.8 measured at 85 lpm using a DOP aerosol. |
| Web F5 | Polypropylene high loft Spunbond, prepared as described below |
| Web F6 | Nylon spunbond scrim, with a weight of 10 gsm, available from Cerex |
| | Advanced Fabrics, Inc., Cantonment, FL |
| Web F7 | A non-woven melt blown fibrous web comprising polypropylene fibers |
| | having an effective fiber diameter of 4.8 micrometers, with a charging |
| | additive package as described in U.S. Pat. No. 10,724,171, which can be prepared per |
| | Process A disclosed in U.S. Pat. No. 10,724,171, having a basis weight 16.5 gsm and |
| | wherein the quality factor is 0.05. |
| Web F8 | A non-woven melt blown fibrous web comprising polypropylene fibers |
| | having an effective fiber diameter of 4.8 micrometers, with a charging |
| | additive package as described in U.S. Pat. No. 10,724,171, which can be prepared per |
| | Process A as disclosed in U.S. Pat. No. 10,724,171, having a basis weight 73 gsm and |
| | wherein the quality factor is 0.05. |
| Web F9 | A non-woven melt blown fibrous web comprising polypropylene fibers |
| | having an effective fiber diameter of 4.5 micrometers, with a charging |
| | additive package as described in U.S. Pat. No. 10,724,171, which can be prepared per |
| | Process A as disclosed in U.S. Pat. No. 10,724,171, having a basis weight 36 gsm and |
| | wherein the quality factor is 0.05. |
| NaCl | Sodium chloride ACS regent grade NaCl 2% weight solution in deionized |
| | water. |
| DOP | Dioctyl Phthalate, Sigma Aldrich |

### Preparation of Web F5:

High loft spunbonded filter nonwoven material was prepared as follows. Continuously extruded meltspun fibers were made and collected in general accordance with the procedures described in the Examples of U.S. Pat. No. 8,240,484 (Fox et al.). The collected fibers were autogenously bonded to form self-supporting, spunbonded webs in general accordance with the procedures described in U.S. Pat. No. 9,976,771 (Chen et al.), and were area-bonded using calendaring methods of the general manner described in U.S. Pat. No. 8,240,484. The area-bonds were estimated to be present at an area percentage of the web of approximately 1.5-1.6%. The webs were hydrocharged in general accordance with the procedures disclosed in U.S. Patent Application Publication No. 2012/0017910 (Li et al.). The flat-web samples exhibited a basis weight of approximately 55 grams per square meter (g/m²).

The flat-web samples were then relofted by needle-punching. The needles were provided (in a topside-punching arrangement including a top hole-board and a bottom hole-board with approximately 50 mm vertical spacing therebetween) in 32 rows, each row extending across an 85 cm lateral (crossweb) width with the rows being spaced along a 28.5 cm downweb extent. Each row had 104 needles (the within-row needle spacing was thus approximately 8 mm). The needles were of the general type available under the trade designation 609831 15X18X25X3 1/2 R333 G 3007, from GROZ-BECKERT, Albstadt, Germany. The web was passed through the needle-puncher in a continuous manner at a speed of around meters per minute. As the web passed through the needle-punching unit it was needle-punched at a rate of approximately 350 strokes per minute. From these parameters it was estimated that the web was punched at a density of approximately 25 punches per square centimeter of web material. The punching was performed from one side (the top side) only.

The increase in loft of the web was notably evident even upon casual visual inspection. That is, the relofted web was noticeably thicker and “fuzzier” than the as-received web, and very few of the area-bonded areas were still visible; rather, they seemed to be obscured by fibers that were overlying them.

The relofted web exhibited a very uniform appearance and had an effective fiber diameter (EFD) of 28 micrometers and a solidity of 3.9%.

### Test Methods

The following test methods were used to evaluate examples.

### Initial Percent Penetration, Pressure Drop and Quality Factor Test:

Pressure drop and percent penetration were determined using a challenge containing NaCl or DOP particles, delivered at a flow rate of 85 liters/min (LPM), and evaluated using an automated filter tester (CERTITEST model 8130 from TSI Inc., Shoreview, MN). A pressure transducer (available from MKS Instruments, Andover, MA) was used to measure pressure drop or delta P (dP, mm H₂O) through the sample during testing.

For NaCl testing, 0.075 μm diameter particles were used. The particles were generated from a 2% NaCl solution to provide an aerosol containing particles at an airborne concentration of about 16-23 mg/m³. The automated filter tester was operated with both the heater and particle neutralizer on. The initial penetration and pressure drop tests last about 19 seconds.

For DOP testing, the aerosol contains particles with a nominal diameter of about 0.185 μm at a target concentration of about 100 mg/m³. The automated filter tester was operated with both the heater and particle neutralizer off. The initial penetration and pressure drop tests last about 21 seconds.

The NaCl or DOP particles are forced through either (i) a media sample disk cut to have a test area that was 11.4 cm in diameter or a 102 cm² opening, or (ii) through the breathing filter area if a respirator was tested, at a rate of 85 LPM.

The DOP or NaCl percent penetration is defined by the following formula:

% Pen=(Concentration downstream/Concentration upstream)×100

The DOP or NaCl percent penetration and pressure drop are used to calculate a quality factor “QF” by the following formula:

$$QF [ 1 / mm {H}_{2} O ] = \frac{- ln ( \% Pen / 100 )}{Pressure Drop ( mm {H}_{2} O )}$$

NaCl Loaded Percent Penetration, Pressure Drop and Quality Factor Test: NaCl Loading Test: (over time)

This test was run similar to the initial Percent Penetration, Pressure Drop and Quality Factor above, except that the filter was exposed to a continuous flow of NaCl aerosols until the exposure reached 60 mg of NaCl at 85 1 μm. The resulting pressure drop and percent penetration was determined and the QF value calculated. Loading tests were performed on the automated filter tester according to the procedure set forth in the tester manual. The samples received continuous NaCl challenge at 85 LPM with both the heater and the particle ionizer on. Tested flat samples had an exposed area of 102 cm² with a nominal face velocity of 13.8 cm/sec for flat media sheets.

The samples were loaded with NaCl particles until the loaded NaCl mass reached 60 g. Calibrated photometers were employed at the filter inlet and outlet to measure the particle concentration and the % particle penetration through the filter.

### Web Thickness:

Due to the lofting (i.e., structural ratio of fiber to air) of the nonwoven media, slight pressure is applied at about 0.1 g/cm² to measure the web thickness. The reported web thickness are averages of at least 6 measurements.

### Basis Weight:

The average web basis weight was determined by weighing with a balance a precise area of web. The reported basis weights are averages of at least 2 samples.

Topography images:

Topography analysis of selected samples was performed following the process per ISO standards BS EN 16610-21 and ISO 25178-2.

Approximately a 4 cm×6 cm area of media was analyzed for microscopic images using a Keyence VR5200 microscope available from Keyence Corp. of American (Itasca. IL, USA).

Method of Making Media 1 with Stretched Filaments:

Two pieces of web, 12-inch (305 mm)-wide by 50 to 70 inches (1270 to 1778 mm)-long were sprayed on one side with adhesive. The webs were sprayed with 1-2 passes of adhesive from one to two feet (0.3 to 0.6 m) away. The adhesive-sprayed webs were then left air dry for few minutes.

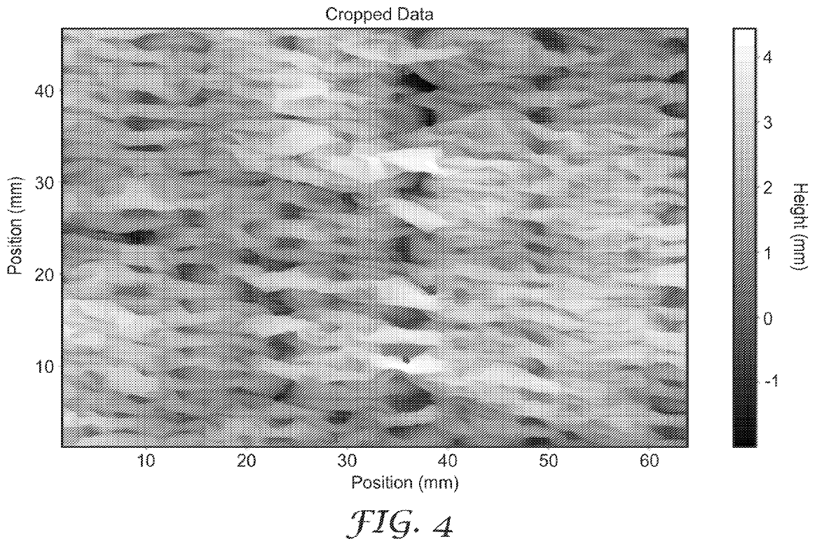

As the beam comprised a plurality of parallel filaments with a spacing of 8 filaments per inch that are held in alignment with a permanently mounted comb. As the filaments are unwound from the beam, all of the filament ends from the spool were secured with a knot. The plurality of filaments was unwound from the spool and a second knot was tied in the plurality of filaments about 40 to 60 inches (102 to 152 cm) from the first knot. The cord, comprising a plurality of filaments tied at both ends, then was cut from the spool. A comb was used near each end of the cord to space the filaments at 8 strands per inch. One tied end of the cord was held in place with a heavy weight, such that it did not move. The opposing tied end was manually stretched to a designated percentage of its original length. Stretch was calculated as the difference between length of the stretched filament and the initial filament when relaxed divided by the length of the initial filament converted to a percent. Shown in FIG. 3 is exemplary configuration of a first series of filaments 32, wherein the filaments are tied at either end and combs 35 and 37 are used at both ends to hold the filaments substantially parallel. The first series of filaments are placed between first non-woven porous fibrous web 34 and second non-woven porous fibrous web 36.

One of the adhesive-sprayed webs prepared as described above was placed below the stretched plurality of parallel filaments with the adhesive side contacting the filaments. The second adhesive-sprayed web was placed above the stretched plurality of parallel filaments with the adhesive side contacting the filaments. Then, a cardboard roller was used to compress the laminate gently to remove any air pockets so that the two nonwoven webs were adhered together with the filaments positioned in between the two webs.

If indicted, Web 6 was sprayed with the adhesive and positioned with the adhesive contacting one side of the laminate. The article was pressed with a cardboard roller.

The manual hold of the stretched plurality of parallel filaments was released, and the filaments were allowed to relax causing the laminated media (web-adhesive-filament-adhesive-web-optional web F6) to pucker.

Method of Making Media 1 without filaments nor adhesive:

Comparative examples were made following the same method as described in Method of making media 1 with stretched filaments as described above, except for no filaments and no adhesive was used. Therefore, the resulting laminated media was (web-web).

### Method of Making Media II:

The same method as described in Method of making media 1 with stretched filaments as described above was used except for the following modifications: instead of 1 cord tied at both end, 2 cords tied at both ends were used and combs were used near each end of the cords to space the filaments at 8 strands per inch in each cord. One side of the first cord was held in place with a heavy weight, such that it did not move. The opposing tied end of the first cord was manually stretched to a designated percentage of its original length. One side of the second cord was held in place with a heavy weight and the opposing tied end of the second cord was manually stretched to a designated percentage of its original length. The two stretched cords were arranged such that the plurality of filaments where perpendicular to one another.

The perpendicular arranged filaments were then laminated between the two nonwoven webs as described in the Method of making media 1 with stretched filaments above, resulting in a laminated media (web-adhesive-filament 1-filament 2-adhesive-web).

### Method of Making Shaped Media:

A cup-shaped disposable respirator was fabricated by first placing the designated media over a pre-molded cup-shaped shell with the wrinkles generally in the direction perpendicular to direction from nose to chin on the shell. The cup-shaped shell generally has a volume of about 230 milliliter and was made from the same shell material as the respirator available under the trade designation 3M PARTICULATE RESPIRATOR 8210 available from 3M Co. . . . Maplewood, MN, USA). To conform to the curvature of cup shape, the wrinkled media at the two sides next to staple or welding areas for respirator headbands were arranged to form folds. Then the wrinkled media and shell were welded together around the cup periphery to form the cup-shaped respirator.

The wrinkled media can be welded to the shell with wrinkles oriented in any other direction as well.

### Properties and Performance of Individual Webs

A single sheet of each of the flat webs as designated in Table 1 were measured for basis weight and thickness and their performance in the NaCl test are shown in Table 1.

TABLE 1

| | | | NaCl Test results | | |
|---|---|---|---|---|---|
| | Basis | | | Initial | |
| | Weight | Thickness | Initial dP | Pen | |
| Web | (g) | (mm) | (mm H₂O) | (%) | QF |
| F1 | 44 | 0.45 | 12.9 | 0.01 | 0.71 |
| F2 | 61 | 0.88 | 6.8 | 0.17 | 0.94 |
| F3 | 61 | 0.90 | 3.4 | 4.7 | 0.90 |
| F4 | 18 | 0.19 | 2.6 | 10.6 | 0.86 |
| F5 | 55 | 1.28 | 0.2 | 71.6 | 1.67 |
| F6 | 10 | 0.10 | NA | NA | NA |
| F7 | 16.5 | 0.21 | 4.6 | 81 | 0.05 |
| F8 | 73 | 0.99 | 20.0 | 49 | 0.05 |
| F9 | 36 | 0.39 | 10.2 | 59 | 0.05 |

### Impact of Adhesive

The impact of Adhesive on performance was tested on 2 different webs as shown in Table 2. One layer of web was tested per the NaCl Loading Test. Two layers of web were also tested, some with no adhesive between the layers and others with 1, 2, or 3 passes of Adhesive sprayed on one side of one web and then contacted with the second web to adhere the two webs together. Each sample was tested following the Initial Percent Penetration, Pressure Drop and Quality Factor Test described above using NaCl particles. Shown in Table 2 are the sample configurations and the results if tested.

TABLE 2

| | Number | | | |
|---|---|---|---|---|
| | of | | DOP Test Results | |
| Type of | layers | Passes of | Initial dP | |
| web | of web | Adhesive | (mm H₂O) | Initial Pen (%) |
| Web F2 | 1 | 0 | 6.3 ± 0.1 | 0.397 ± 0.039 |
| | 2 | 0 | 13.1 ± 0.2 | 0.003 ± 0.004 |
| | 2 | 1 | 12.7 ± 0.3 | 0.002 ± 0.001 |
| | 2 | 2 | 12.8 ± 0.3 | 0.002 ± 0.001 |
| Web F1 | 1 | 0 | 13.04 ± 0.2 | <0.001* |
| | 2 | 1 | 25.79 ± 0.3 | <0.001* |
| | 2 | 3 | 26.35 ± 0.2 | <0.001* |

*Below detection limit

As shown in Table 2, above, there is a difference in the Initial dP, based on 1 or 2 layers of web used, however the adhesive presence and amount does not appear to impact the Initial dP or % Initial Penetration. The Basis Weight was determined for the various samples and the results showed that the basis weight with the presence of adhesive did not change outside of the expected standard deviation.

### Examples 1~4 (EX 1-EX 4)

Various laminated articles were prepared using web F4 following the Method of making media 1 with stretched filaments as described above. The filaments were stretched to various percentages as listed in Table 3. Each sample was then tested following the Initial Percent Penetration, Pressure Drop and Quality Factor Test using NaCl particles. The results are shown in Table 3. A Topography image of EX 3 is shown in FIG. 4.

### Comparative Example 1 (CE1)

A sample was prepared using two webs F4 following the Method of making media 1 without filaments as described above. The sample was then tested following the Initial Percent

Penetration, Pressure Drop and Quality Factor Test using NaCl particles. The results are shown in Table 3.

TABLE 3

| | | NaCl Test results | | | |
|---|---|---|---|---|---|
| | | | Initial | | |
| | Stretch | Initial dP | Pen | Calculated | QF % increase |
| Sample | % | (mm H₂O) | (%) | QF | over CE 1 |
| CE 1 | NA | 4.7 | 9.8 | 0.5 | NA |
| EX 1 | 50 | 2.8 | 0.61 | 1.8 | 274 |
| EX 2 | 100 | 2.7 | 0.26 | 2.2 | 352 |
| EX 3 | 150 | 2.7 | 0.46 | 2.0 | 307 |
| EX 4 | 200 | 2.9 | 0.35 | 2.0 | 300 |

NA = not applicable

### Example 5 (EX 5)

A laminated article was prepared using web F4 following the Method of making media 1 with stretched filaments as described above. The filaments were stretched to 200%. Web 6 was then adhesively bound to one side of the laminate as described in the Method of Making Media 1 with stretched filaments above.

### Examples 6-10 (EX 6 to EX 10)

Various laminated articles were prepared using two different webs, one web F2 and one web F3, in the laminate, the filaments were positioned between web F2 and web F3 following the Method of Making Media 1 with Stretched Filaments described above. The filaments were stretched to various percentages as listed in Table 3. Each sample was then tested following the Initial Percent Penetration, Pressure Drop and Quality Factor Test using NaCl particles with the F3 web on the upstream side during testing. The results are shown in Table 4.

### Comparative Example 2 (CE 2)

A sample was prepared using one web F2 adhesively adhered to one web F3 following the Method of making media 1 without filaments as described above. The sample was then tested following the Initial Percent Penetration, Pressure Drop and Quality Factor Test using NaCl particles with the F3 web on the upstream side during testing. The results are shown in Table 4.

TABLE 4

| | | NaCl Test results | | | |
|---|---|---|---|---|---|
| | | | Initial | | |
| | Stretch | Initial dP | Pen | Calculated | QF % increase |
| Sample | % | (mm H₂O) | (%) | QF | over CE 2 |
| CE 2 | NA | 9.6 | 0.014 | 0.92 | NA |
| EX 6 | 50 | 7.8 | 0.010 | 1.19 | 29 |
| EX 7 | 75 | 8.0 | 0.010 | 1.15 | 25 |
| EX 8 | 100 | 8.8 | 0.006 | 1.10 | 20 |
| EX 9 | 150 | 10.3 | 0.01 | 0.90 | −3 |
| EX 10 | 200 | 10.9 | 0.003 | 0.89 | −4 |

### Example 11 (EX 11)

The Method of Making Media 1 with Stretched Filaments described above was used to make a filter media using the web F5. The sample tested following the Initial Percent Penetration, Pressure Drop and Quality Factor Test using both NaCl and DOP particles. The results are shown in Table 5 below.

### Comparative Example 3 (CE 3)

A sample was prepared using one web F5 adhesively adhered to another web F5 following the Method of making media 1 without filaments as described above. The sample tested following the Initial Percent Penetration, Pressure Drop and Quality Factor Test using both NaCl and DOP particles. The results are shown in Table 5A below.

TABLE 5A

| | | NaCl test results | | | | DOP test results | | | |
|---|---|---|---|---|---|---|---|---|---|
| | | | | | QF % | | | | QF % |
| | | Initial | Initial | | increase | Initial | Initial | | increase |
| | Stretch | dP | Pen | Calculated | over | dP | Pen | Calculated | over |
| Sample | % | (mm H₂O) | (%) | QF | CE 3 | (mm H₂O) | (%) | QF | CE 3 |
| CE 3 | NA | 0.4 | 48.3 | 2.1 | NA | 0.4 | 47.3 | 1.7 | NA |
| EX 11 | 100 | 0.6 | 24.3 | 2.4 | 13 | 0.6 | 26.6 | 2.2 | 34 |

To test the impact that stretching has on the puckered or shirred material, samples from Example 11 were stretched and held to varying degrees and tested following the Initial Percent Penetration, Pressure Drop and Quality Factor Test using DOP particles. The samples from Example 11 were stretched in the same direction as the length of the filaments to expand the samples and then held in place by mechanically fixing the media at the sides. The expansion ratio reported in Table 5B represents the length of the shirred media when a lengthwise force is applied on the media to the length of the shirred media when no force is applied on the media. For example, an Expansion ratio of 1.0 means the no expansion of the sample took place, whereas in an Expansion ratio of 1.5, the sample was stretched lengthwise by 50% resulting in an Expansion ratio of 1.5. The results are shown in Table 5B below.

TABLE 5B

| | | DOP test results | | |
|---|---|---|---|---|
| | | Initial | | |
| | | dP | Initial | |
| | Expansion | (mm | Pen | Calculated |
| Sample | ratio | H₂O) | (%) | QF |
| EX 11 | 1.0 | 0.6 | 26.6 | 2.24 |
| | 1.2 | 0.6 | 28.7 | 2.27 |
| | 1.5 | 0.5 | 31.5 | 2.46 |
| | 1.8 | 0.5 | 33.9 | 2.30 |

### Examples 12 and 13 (EX 12-EX 13)

The Method of Making Media 1 with Stretched Filaments described above was used to make a filter media using the various webs as described in Table 6 below. The filaments were stretched to 100%. The samples were tested following the Initial Percent Penetration, Pressure Drop and Quality Factor Test using NaCl particles. The bottom web was on the upstream side during testing. The results are shown in Table 6 below.

### Comparative Examples 4 and 5 (CE 4-CE 5)

Samples were prepared using the various webs as described in Table 6 below. The Method of making media 1 without filaments as described above was used to prepare the samples. The samples were tested following the Initial Percent Penetration, Pressure Drop and Quality Factor Test using NaCl particles. The bottom web was on the upstream side during testing. The results are shown in Table 6 below.

TABLE 6

| | | | NaCl Test results | | |
|---|---|---|---|---|---|
| | Top | | | | QF % |
| | Web | Bottom Web | Initial dP | Calculated | increase |
| Sample | used | used | (mm H₂O) | QF | over CE |
| CE 4 | F1 | F5 | 13.1 | 0.7 | NA |
| EX 12 | F1 | F5 | 8.9 | 1.6 | 109 |
| CE 5 | F6 | F5 | 0.27 | 1.4 | NA |
| EX 13 | F6 | F5 | 0.32 | 2.2 | 55 |

### Example 14 (EX 14)

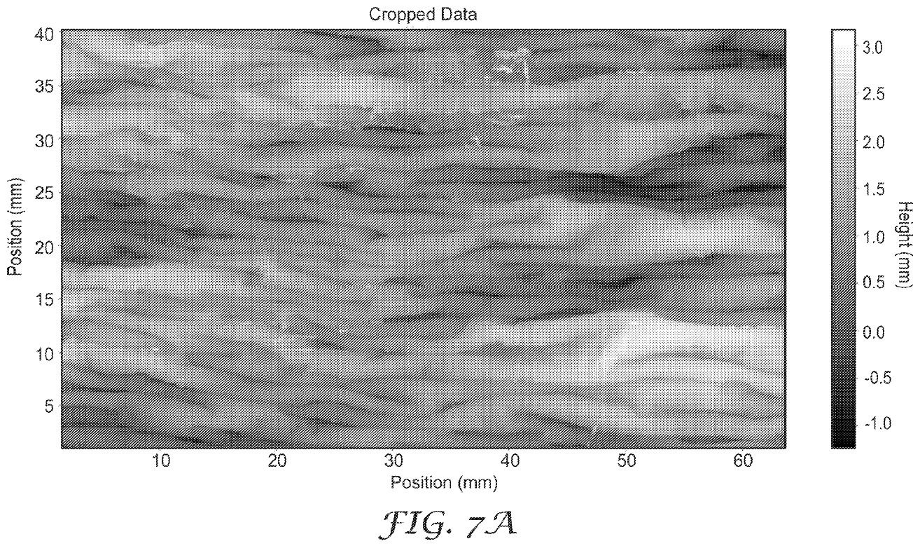

The Method of Making Media II with Stretched Filaments described above was used to make a filter media using web 2 with the filaments stretched to 75% in both sets of filaments. A Topography Image of the sample is shown in FIG. 6. The sample was tested following the Initial Percent Penetration, Pressure Drop and Quality Factor Test using NaCl particles and the NaCl Loaded Percent Penetration, Pressure Drop and Quality Factor Test described above. The results are shown in Table 7 below.

### Comparative Example 6 (CE 6)

The Method of Making Media 1 without filaments nor adhesive described above was used to make a filter media using web 2. The sample was tested following the Initial Percent Penetration, Pressure Drop and Quality Factor Test using NaCl particles and the NaCl Loaded Percent Penetration, Pressure Drop and Quality Factor Test. The results are shown in Table 7 below.

TABLE 7

| | | Initial NaCl Test results | | | NaCl Loading Test results | | |
|---|---|---|---|---|---|---|---|
| | | | | QF % | dP with | Calculated | QF % |
| | | Initial | | increase | 60 mg | QF with | increase |
| | Stretch | dP | Calculated | over | NaCl Loaded | 60 mg | over |
| Sample | % | (mm H₂O) | QF | CE 6 | (mm H₂O) | NaCl Loaded | CE 6 |
| CE 6 | NA | 13.3 | 1.0 | NA | 32.9 | 0.24 | NA |
| EX 14 | 75 | 13.5 | 1.0 | −1 | 19.7 | 0.51 | 118 |

### Examples 15 (EX 15)

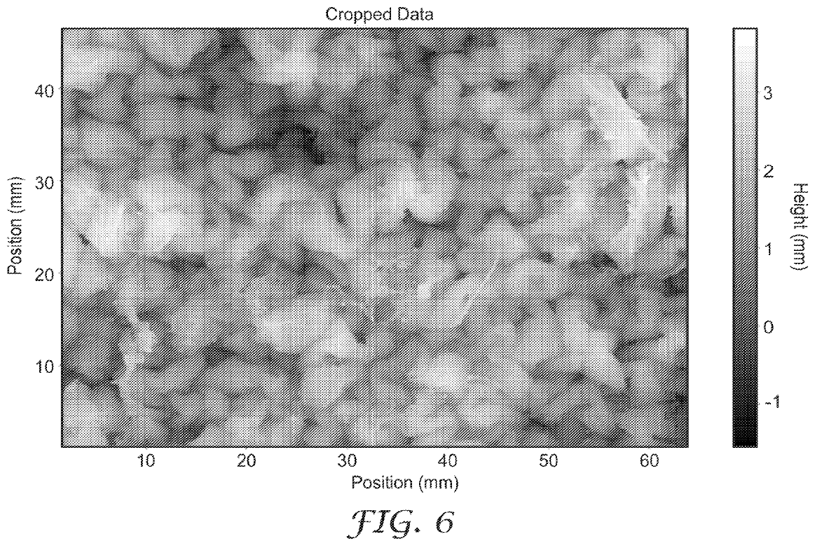

The Method of Making Media 1 with Stretched Filaments described above was used to make a filter media using the web F9. The filaments were stretched to 150%. The samples were tested following the Initial Percent Penetration, Pressure Drop and Quality Factor Test using NaCl particles. The results are shown in Table 8 below. A Topography Image of EX 15 was taken and is shown in FIG. 5.

### Comparative Example 7 (CE 7)

The Method of making media 1 without filaments as described above used to make a filter media using the web F9. The sample was tested following the Initial Percent Penetration, Pressure Drop and Quality Factor Test using NaCl particles. The results are shown in Table 8 below.

TABLE 8

| | | NaCl Test results | | | |
|---|---|---|---|---|---|
| | Stretch | Initial dP | Initial Pen | Calculated | QF % increase |
| Sample | % | (mm H₂O) | (%) | QF | over CE |
| CE 7 | NA | 34.7 | 21.8 | 0.04 | NA |
| EX 16 | 150% | 19.1 | 23.0 | 0.08 | 75 |

### Example 16 (EX 16)

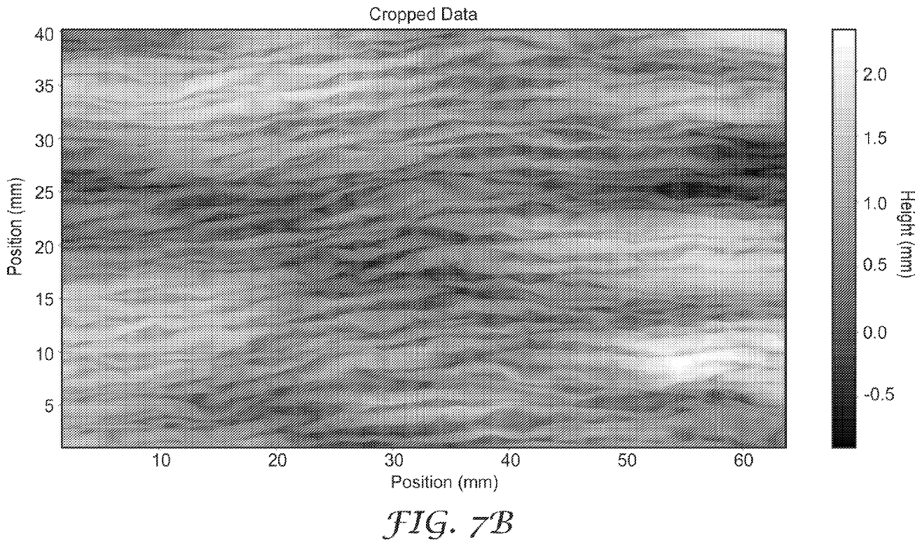

A sample was prepared using Webs F7 and F8 following the Method making media 1. The Web F7 was on top and Web F8 was at the bottom. The filaments were stretched to 200%. A Topography Image of the sample was taken and is shown in FIGS. 7A and 7B, where FIG. 7A is the Web F7 side and FIG. 7B is the Web F8 side.

### Comparative Example 8-9 (CE 8 to CE 9) and Examples 17-19 (EX 17 to EX 19)

The media as designated EX 1, EX 2 and EX 4 in Table 3 was used to make EX 17 to EX 19 following the Method of Making Shaped Media as described above. CE 8 was a cup-shaped respirator available under the trade designation 3M DISPOSABLE RESPIRATOR 1860 available from 3M CO., Maplewood, MN, USA. CE 9 was a cup-shaped respirator available under the trade designation 3M DISPOSABLE RESPIRATOR 8210 available from 3M CO., Maplewood, MN, USA. The samples were tested following the Initial Percent Penetration, Pressure Drop and Quality Factor Test using NaCl particles. The results are shown in Table 9.

TABLE 9

| Sample | Media Used | Initial dP (mm H₂O) | Calculated QF |
|---|---|---|---|
| EX 17 | EX 1 | 2.6 | 2.7 |
| EX 18 | EX 2 | 2.4 | 2.7 |
| EX 19 | EX 4 | 2.6 | 2.6 |
| CE 8 | 1860 | 8.3 | 0.8 |
| CE 9 | 8210 | 8.1 | 0.7 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A shirred filter media comprising a first series of substantially parallel non-bonded elastic filaments between a first and a second non-woven porous fibrous web, wherein the first non-woven porous fibrous web is directly bonded to the second non-woven porous fibrous web, wherein at least one portion of the shirred filter media is resiliently extensible under tension.

2. The shirred filter media of claim 1, wherein at least one of the first or second non-woven porous fibrous webs comprise electret fibers.

3. The shirred filter media of claim 2, wherein the electret fibers comprise a charging additive in a polymeric resin, optionally wherein the polymeric resin is a polyolefin or polypropylene.

4. The shirred filter media of claim 1, wherein the at least two webs are bonded together with an adhesive wherein the weight per unit area of the adhesive is less than the weight per unit area of the non-woven porous fibrous webs in the shirred filter media.

5. The shirred filter media of claim 4, the shirred filter media comprises at least 1 gsm and at most 80 gsm of adhesive.

6. (canceled)

7. The shirred filter media of claim 1, wherein the at least two webs are bonded together by thermal bonding or ultrasonic welding.

8. The shirred filter media of claim 1, wherein the elastic filaments are uniformly spaced at about two to about twenty-five filaments per inch width.

9. (canceled)

10. (canceled)

11. The shirred filter media of claim 1, wherein the non-bonded elastic filaments are maintained under partial tension in the shirred filter media.

12. The shirred filter media of claim 1, wherein the shirred filter media is elastically extensible to at least about twice its relaxed length.

13. The shirred filter media of claim 1, wherein the shirred filter media further comprises a second series of substantially parallel non-bonded elastic filaments between the at least two non-woven porous fibrous webs, wherein the second series of substantially parallel non-bonded elastic filaments is not parallel to the first series of substantially parallel non-bonded elastic filaments.

14. The shirred filter media of claim 1, wherein at least one portion of the shirred filter media is resiliently extensible under a first tension, wherein a second portion of the shirred filter media is under a second tension.

15. The shirred filter media of claim 1, wherein the shirred filter media has an air permeability of greater than or equal to 2 CFM.

16. The shirred filter media of claim 1, wherein the non-woven porous fibrous web has a basis weight of between 15 to 180 gsm.

17. (canceled)

18. (canceled)

19. The use of the shirred filter media according to claim 1 for filtering particles.

20. An article comprising the shirred filter media according to claim 1.

21. (canceled)

22. The article of claim 20, wherein the article is a respirator.

23. The article of claim 20, wherein the article is a heating, ventilation, and/or air conditioning equipment filter; an air purifier filter; an air conditioning device filter; a portable fan filter; or a vent filter.

24. (canceled)

25. A method of filtering particles from vaporous fluids, the method comprising passing the vaporous fluid through the media according to claim 1.

26. The method of making a shirred filter media, the method comprising:
stretching a first series of substantially parallel non-bonded elastic filaments to a first length forming stretched filaments;
placing the stretched filaments between a first and a second non-woven porous fibrous web forming a multilayered construction;
bonding the first non-woven porous fibrous web to the second non-woven porous fibrous web with the stretch filaments therebetween; and
releasing the stretched filaments to form the shirred filter media, wherein at least one portion of the shirred filter media is resiliently extensible under tension.
